(19) United States
(12) Patent Application Publication
(10) Pub. No.: US 2003/0074499 A1
(43) Pub. Date: Apr. 17, 2003

(54) Multifactorial transmission-exchange device for stroring media

(75) Inventors: Chia-Li Chen, Hsin Tien City (TW); Wen-Tsung Liu, Hsin Tien City (TW); Mi-Chang Chen, Hsin Tien City (TW)

Correspondence Address: BACON & THOMAS, PLLC, 625 SLATERS LANE, FOURTH FLOOR, ALEXANDRIA, VA, 22314

(73) Assignee: Carry Computer Eng., Co., Ltd.

(21) Appl. No.: 09/973,740

(22) Filed: Oct. 11, 2001

(51) Int. Cl. G06F 13/12

(52) U.S. Cl. 710/63

(57) ABSTRACT

A multifactorial transmission-exchange device for storing media, wherein, by designing that two applied chip sets control a reading disk and an insertion cassette, data transmission and exchange between a compact disk and a silicon disk can be completed without aiding of a computer mainframe system; the applied chip sets, reading disk and insertion cassette are provided in a main body further having therein a circuit plate, a microprocessing unit and a transmission interface, so that the main body can be built in a computer mainframe system, and multifactorial data transmission, exchange and reading/writing among the silicon disk, compact disk and computer mainframe system can be completed. Or by providing another power supplying unit to supply power for operating a circuit board, the device can be used alone to execute data transmission and exchange for the silicon disk and compact disk, these all satisfy multiple requirements of users in using various storing media.

### BACKGROUND OF THE INVENTION

1. Field of the invention

The present invention is related to a multifactorial transmission-exchange device for storing media, the device can be built in or externally connected to a computer mainframe system or can be used alone. Through the present invention, data in the computer mainframe system, a compact disk and a silicon disk can be read and exchanged in a multifactorial mode to satisfy multiple requirements of users in using various storing media.

2. Description of the Prior Art

In the recent years, prevailing of Internet has provided convenient channels for data transmission and exchanging, technical limitations such as transmission speed and unmatching in the wireless communication network construction etc. still make computer mainframe systems take storing media as the main media during data transmission and exchanging; additionally, adoption in large amount of various portable digital products such as the goods which sell well like personal digital assistants (PDA), digital cameras (DSC), digital walkmans (MP3 Players) etc. nearly all have silicon disks as their storing media; so that computer mainframe systems even more rely on storing media.

Recalling the development of the industry of storing media, there are generally three stages: namely, the stages of the magnetic recording media, the photo-recording media and the silicon chip recording media. They are now described as below:

1. The Magnetic Recording Media (Magnetic Disks)

Since the magnetic recording media (magnetic tapes, magnetic cards etc.) were developed in 1967, they have been being continuously adopted by people; however, they have the problems of slowness in reading, inferiority of safety in preservation of information etc. as compared to compact disks or silicon disks, their positions and roles in recording media have been gradually substituted by the rising products compact disks and silicon disks and lost their marketing value.

2. The Photo-Recording Media (Compact Disks)

To solve the problem of safety in preservation of information with storing media, the photo-recording media take the place of the earlier magnetic recording media. The technique of compact disks in its initial period is endued with the feature of safety in preservation of information, however, its speed of accessing of information is slower, and can not satisfy the requirement of multimedia information storage such as letters, pictures, images and motion pictures etc. Within several years thereafter, various applied products such as CD-ROM, CD-DA, CD-I, Photo-CD, Video-CD and the most brand-new DVD with a capacity of being elevated up to 4.7 GB/unit chip have been derived following advance of optics. Dividing by function, the CD-ROM players used nowadays can be divided into three types, i.e., the read only CD-ROM (CD-ROM, DVD-ROM) players, the read and write CD-ROM (CD−RW, DVD−RW, DVD+RW) players and the Combo (with both functions of the DVD-ROM and the DVD−RW) players.

3. The Silicon Chip Recording Media (Silicon Disks)

A silicon disk is a memory card made from a silicon chip; it is generally called a portable memory card. By the fact that a silicon disk is light, thin and short, and has the excellent features of saving electric power, high storing capacity, vibration durability as well as repeated memorizing etc., they are widely used for IA-information appliances and multiple portable digital products. And by the fact that a magnetic disk or a compact disk is inferior in respect to the influences on size, vibration, collision and electric consumption, silicon disks are used as peripheral provisions for IA-information appliances (mostly are used to record digital images and sounds), and are gradually used as consumptive goods. Therefore, in future designing for miniaturization of portable devices used outdoors, requirement for those silicon disks with their volumes each even smaller than that of a compact disk gets more and more larger. Thereby, in the markets of storing media, the storing media of silicon chips (silicon disks) form another mainstream in addition to compact disks.

However, the abovementioned two mainstreams of storing media compact disks and silicon disks still cannot satisfy consumers of which the number gets larger and larger, this is because mainly of that the information recorded on these two storing media must rely on reading and exchanging of computer mainframe systems, for example: when a user wants to transmit information in a compact disk to a silicon disk for recording, he must have the data exchange processed through a computer mainframe system simultaneously provided with a compact disk and a silicon disk; and during processing, the data in the a compact disk must be stored in the hard disk of the computer firstly, and then is in turn transmitted from the hard disk to the silicon disk; after that, the information in the hard disk shall be deleted in order not to occupy too much space in the hard disk.

The above conventional data exchanging mode among recording media is quite time consuming; the entire procedure can be completed if time consuming can be accepted, but it still is inconvenient. An even larger problem is, it may be the case that a compact disk has been being the standard provision of a computer mainframe system, and silicon disks still cannot be of any standard provisions due to the problem of thinking over the cost and ununiformity in specifications; under such a situation, consumers can not help buying a silicon disk additionally to process data exchanging among the recording media. Therefore, it has been the point of consideration of the present invention to know how to effectively integrate the two mainstreams of storing media—compact disks and silicon disks—under the condition to effectively improve the compatibility and convenience in re the specifications and using respectively of compact disks and silicon disks (used in a reciprocal way or in a system-combining way).

### SUMMARY OF THE INVENTION

In particular, the multifactorial transmission-exchange device for storing media of the present invention is provided in the main body thereof with a reading disk for compact disks, a silicon disk insertion cassette, a circuit plate, two applied chip sets, a microprocessing unit and a transmission interface, by providing the reading disk, the insertion cassette and the transmission interface, the main body can be built in or externally connected to a computer mainframe system in order to complete the multifactorial exchange of data transmission and reading/writing etc. among the silicon disk, the compact disk and the computer mainframe system; or it can be used alone by adding another power supplying unit for supplying a power source required by operation of the circuit board, data transmission and exchange for the silicon disk and the compact disk can then be executed without aiding of the computer mainframe system.

The primary object of the present invention is: by independent operation of the multifactorial transmission-exchange device for storing media of the present invention, different storing media can exchange data directly for storage, this provides excellent convenience of using, thus can satisfy the requirements of users in using various storing media.

The secondary object of the present invention is: by that the multifactorial transmission-exchange device for storing media of the present invention unitarily can be built in or externally connected to a computer mainframe system in order to complete the multifactorial exchange of data transmission and reading/writing etc. among a silicon disk, a compact disk and a computer mainframe system, the two mainstreams of storing media—the compact disk and the silicon disk—can be effectively integrated to effectively improve convenience in using the storing media.

Another object of the present invention is: by that the multifactorial transmission-exchange device for storing media of the present invention unitarily can have the function of reading compact disks and silicon disks, the manufacturers of computer mainframe systems can have silicon disk drives built in the mainframe system to meet those systems in the markets, thus competitiveness can be increased.

The present invention will be apparent in the technical content and features thereof after reading the detailed description of the preferred embodiment thereof in reference to the accompanying drawings.

### BRIEF DESCRIPTION OF THE DRAWINGS

FIG. 1 is an anatomic perspective view of the first embodiment of the present invention;

FIG. 2 is a perspective view showing the first embodiment of the present invention is connected to a computer mainframe system;

FIG. 3 is an analytic perspective of the second embodiment of the present invention;

FIG. 4 is a perspective schematic view showing the second embodiment of the present invention is connected to a computer mainframe system.

### DETAILED DESCRIPTION OF THE PREFERRED EMBODIMENT

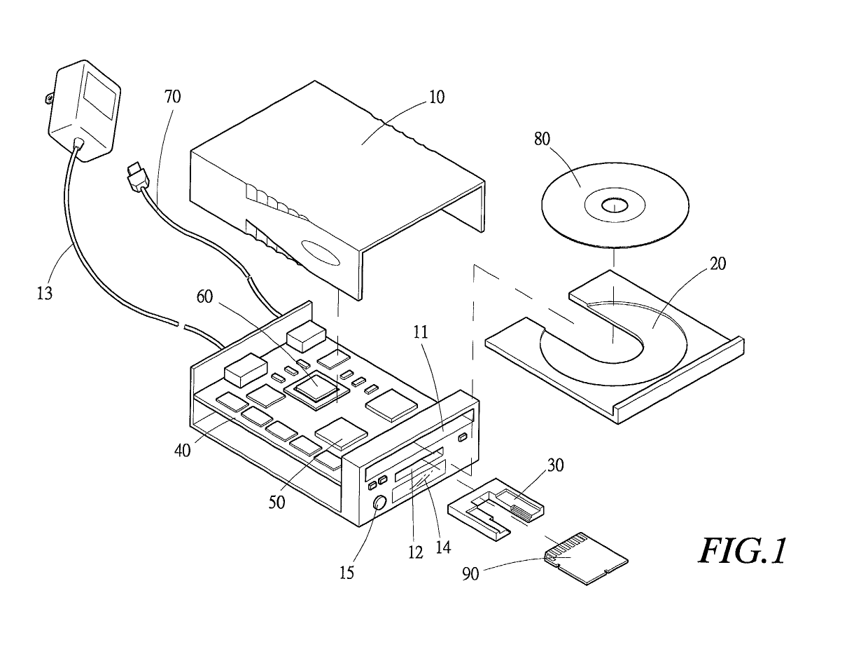

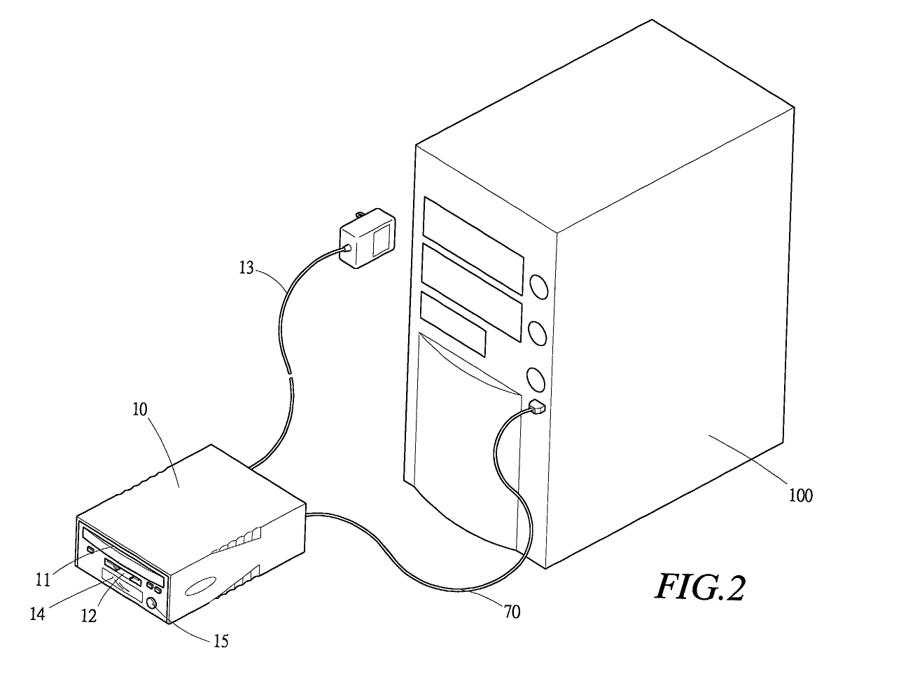

Referring to FIG. 1 and FIG. 2 in the attached drawings, the multifactorial transmission-exchange device for storing media of the present invention has in a main body 10 a reading disk 20 for compact disks, a silicon disk insertion cassette 30, a circuit plate 40, two applied chip sets 50, a microprocessing unit 60 and a transmission interface 70. Wherein:

The main body 10 has a receiving chamber to receive the above members, and is provided on the surface thereof with the insertion slot 11 for a compact disk and a silicon disk insertion slot 12, so that the reading disk 20 and the silicon disk insertion cassette 30 can be placed into the corresponding positions in the main body 10; and a compact disk 80 as well as a silicon disk 90 are placed respectively into the reading disk 20 for compact disks and the silicon disk insertion cassette 30.

Wherein, the silicon disk insertion slot 12 and the silicon disk insertion cassette 30 can be designed to meet several sizes of the specifications including those of the memory cards CF, PCMCIA (PC Card), SMC, MMC, MS or SD; or a plurality of silicon disk insertion cassettes 30 of different specifications can be simultaneously provided to be benefit to using compact disks 80 of different specifications. The reading disk 20 for compact disks can function as a read only CD-ROM player, a read and write CD-ROM player and a Combo player.

When in practicing, for independent using of the present invention, the main body 10 can be provided at the rear thereof with a power supplying unit 13 to supply power for operation, the power supplying unit 13 can be a power line or a storage battery. The main body 10 is provided on the external surfaces thereof with appropriate operating units including a display 14 and a push button 15; besides, in another embodiment, an infrared ray interface (remote control) can be provided for operation.

The circuit plate 40 is provided in the receiving space of the main body 10, the applied chip sets 50 and the microprocessing unit 60 are provided thereon; while the transmission interface 70 is connected at the rear of the main body 10. And the circuit plate 40 is also provided with a register memory and other necessary electronic elements, when the abovementioned compact disk 80 and silicon disk 90 are placed respectively into the reading disk 20 and the silicon disk insertion cassette 30, by operation of the circuit plate 40, the chip sets 50 and the microprocessing unit 60, data exchange between the compact disk 80 and the silicon disk 90 can be executed. If it is necessary, the transmission interface 70 can be connected with a computer mainframe system 100 to transmit the data to the computer mainframe system 100. The transmission interface 70 is preferably a USB interface or a 1394 interface with high transmission efficiency and being more widely used.

The present invention prefers the mode of independent operation, wherein, two different storing media can exchange data directly for storage with a computer mainframe system, this provides excellent convenience of using, thus can satisfy the requirements of users in using various storing media. Certainly, when the compact disk 80 and the silicon disk 90 mutually exchange data for storage, data are read by the reading disk 20 and the silicon disk insertion cassette 30, and are dealt with by the circuit plate 40, the chip sets 50, the microprocessing unit 60, the register memory and other necessary electronic elements, these are conventional techniques and thereby are not further narrated hereinafter.

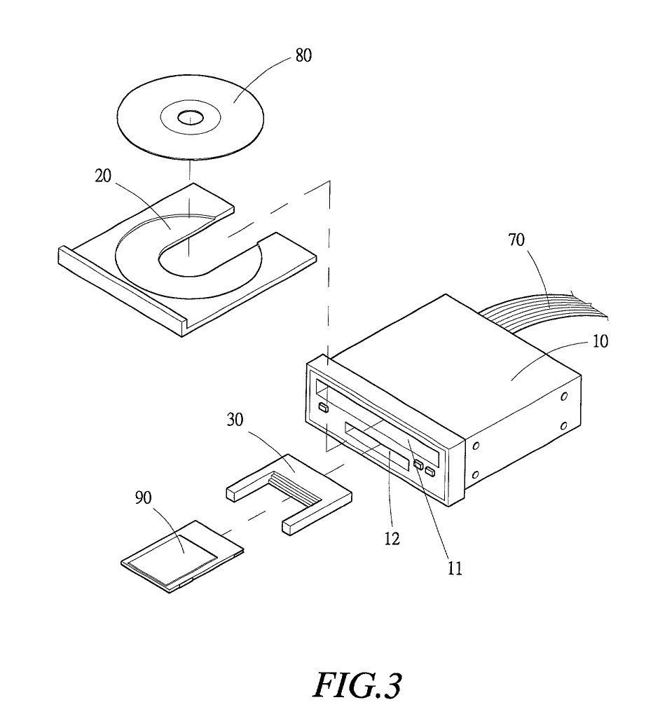

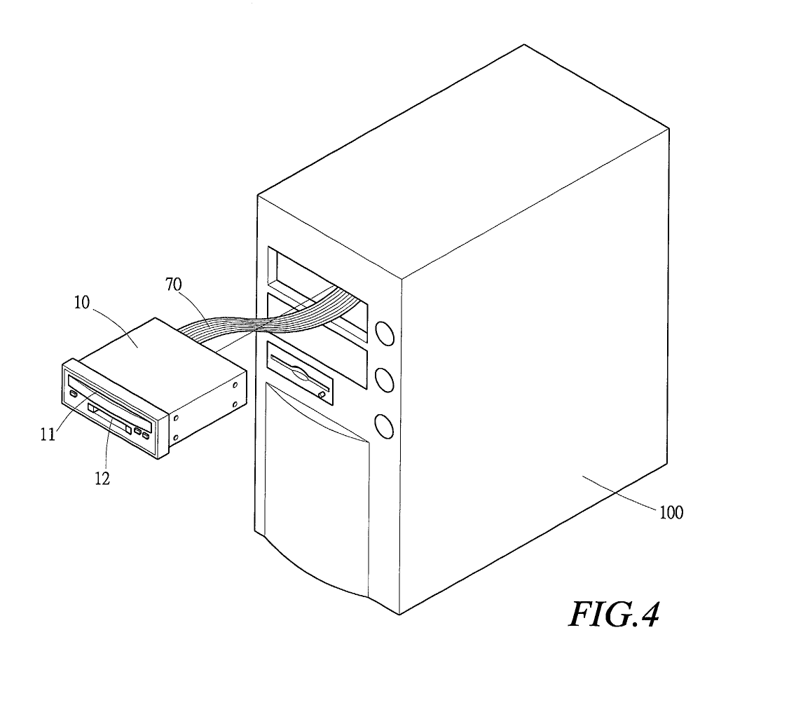

As shown in FIGS. 3 and 4, a second embodiment of the present invention is depicted therein, wherein, the main body 10 is directly built in a computer mainframe system 100, the exchange device unitarily can have the function of reading the compact disk 80 and the silicon disk 90, the manufacturer of the computer mainframe system 100 can have silicon disk drives built therein to meet the systems in the markets under the situation that cost is not increased too much, thus competitiveness can be increased.

When in practicing, the main body 10, the reading disk 20 for compact disks, the silicon disk insertion cassette 30, the circuit plate 40, the chip sets 50 and the microprocessing unit 60 used are all the same as those used as stated above, except that the transmission interface 70 is preferably of more appropriate specifications of a built-in IDE/ATAPI, thereby, when in operation of the circuit plate 40, the chip sets 50 and the microprocessing unit 60, a wanted power source can be supplied directly through the transmission interface 70 of the specifications of the built-in IDE/ATAPI by the computer mainframe system 100, there is no necessity of providing another power supplying unit.

Additionally, by virtue that the embodiment is principally built in a computer mainframe system 100, the contour of the main body 10 thereby is preferred to be rectangular which is benefit to mounting of itself in a slot on the computer mainframe system 100 conveniently. Certainly, after mounting of the main body 10 on the computer mainframe system 100, in operation, commands are given to the computer; thereby the operating units for the main body 10 is no more required here.

According to the first embodiment shown in FIGS. 1 and 2 as well as the second embodiment shown in FIGS. 3 and 4, operation of the present invention is divided into three modes:

1. Independent Use (As Shown in FIGS. 1 and 2):

A power supplying unit 13 is coupled to a power source to supply power for the reading disk 20 for compact disks, the silicon disk insertion cassette 30, the circuit plate 40, the chip sets 50 and the microprocessing unit 60; the compact disk 80 and the silicon disk 90 are placed into the reading disk 20 and the silicon disk insertion cassette 30, through operation of the display 14 and the push button 15 on the main body 10, data exchange between the compact disk 80 and the silicon disk 90 is completed.

2. Externally Connecting to the Computer Mainframe System 100

The transmission interface of the specifications of USB or 1394 is connected between the computer mainframe system 100 and the main body 10, by operation of the computer mainframe system 100, data exchange, reading and writing among the hard disk on the computer mainframe system 100 (not shown), the compact disk 80 and the silicon disk 90 can be executed.

3. Building in the Computer Mainframe System 100 (As Shown in FIGS. 3 and 4):

The main body 10 is fixedly embedded in the slot of the computer mainframe system 100, and is connected with the computer mainframe system 100 via the transmission interface 70 with the specifications of IDE/ATAPI, the computer mainframe system 100 supplies power required to execute data exchange, reading and writing among the hard disk (not shown) on the computer mainframe system 100, the compact disk 80 and the silicon disk 90.

By the multifactorial using modes including the independent use, the building in and the externally connecting to the computer mainframe system of the multifactorial transmission-exchange device for storing media of the present invention, direct data exchange and storage among different storing media can be performed, or the storing media can be used together with the computer mainframe system, thereby users can get excellent convenience in using, and this can satisfy the requirements of users in using various storing media.

Having thus described the technical structure and effects of my invention with novelty and improvement; the above titles and drawings are only for illustrating the technical contents of the preferred embodiments of the present invention, and not for giving any limitation to the scope of the present invention. Various modifications or changes made to the elements of the present invention also fall within the scope of the appended claims and are intended to form part of this invention.

1. A multifactorial transmission-exchange device for storing media, said device is provided in a main body thereof with a reading disk for compact disks, a silicon disk insertion cassette, a circuit plate, two applied chip sets, a microprocessing unit and a transmission interface, wherein:
said main body has a receiving chamber to receive said members listed above, and is provided on the surface thereof with an insertion slot for a compact disk and a silicon disk insertion slot, so that said reading disk for compact disks and said silicon disk insertion cassette are placed into corresponding positions in said main body; and said compact disk as well as said silicon disk are placed respectively into said reading disk for compact disks and said silicon disk insertion cassette;
said circuit plate is provided in the receiving space of said main body, said applied chip sets and said microprocessing unit are provided thereon; while said transmission interface is connected at the rear of said main body, by operation of said circuit plate, said chip sets and said microprocessing unit, data exchange between said compact disk and said silicon disk can be executed; when said transmission interface is connected with a computer mainframe system, data exchange and reading/writing among a hard disk of said computer mainframe system, said compact disk and said silicon disk is performed.

2. A multifactorial transmission-exchange device for storing media as stated in claim 1, wherein,
said silicon disk insertion cassette meets several sizes of the specifications including those of memory cards CF, PCMCIA (PC Card), SMC, MMC, MS or SD.

3. A multifactorial transmission-exchange device for storing media as stated in claim 1, wherein,
said reading disk for compact disks functions as a read only CD-ROM player, a read and write CD-ROM player and a Combo player.

4. A multifactorial transmission-exchange device for storing media as stated in claim 1, wherein said transmission interface is a USB interface, a 1394 interface or an IDE/ATAPI interface.

5. A multifactorial transmission-exchange device for storing media as stated in claim 1, wherein said main body is provided with a power supplying unit to supply power for operation, said main body is provided on the external surfaces thereof with appropriate operating units in favor of operation.

6. A multifactorial transmission-exchange device for storing media as stated in claim 1, wherein said power supplying unit is a power line or a storage battery.
